(19) United States
(12) Patent Application Publication
(10) Pub. No.: US 2025/0329274 A1
(43) Pub. Date: Oct. 23, 2025

(54) ADVERTISING DEVICE

(71) Applicant: Howard Elliott, Creston (CA)

(72) Inventor: Howard Elliott, Creston (CA)

(21) Appl. No.: 18/641,326

(22) Filed: Apr. 19, 2024

(51) Int. Cl. G09F 15/00; G06F 3/14; G09F 9/33

(52) U.S. Cl. CPC G09F 15/0062; G06F 3/14; G09F 9/33

(57) ABSTRACT

An advertising device that is configured to be superposed a suitable horizontal support surface and display a first message and a second message to individuals proximate thereto. The invention includes a first portion and a second portion that are hingedly coupled proximate an upper perimeter edge thereof. The first portion and second portion are identically sized and constructed. The first portion and second portion include a lower display area and an upper display area. The lower display area is operable in a first mode and a second mode. The upper display area includes a graphical display unit operable to display a second message. The first portion and second portion are operably coupled with a securing member at the lower perimeter edge thereof. The graphical display unit has a frame member circumferentially disposed thereto. A controller is provided to provide operation of the graphical display unit altering the messages displayed thereon.

### FIELD OF THE INVENTION

The present invention relates generally to advertising, more specifically but not by way of limitation, an advertising device that is configured to be deployed on a sidewalk or other similar location adjacent to a business wherein the present invention includes a first display area and a second display area and wherein the second display area is a programmable electronic display.

### BACKGROUND

Advertising is employed by millions of businesses on a daily basis. As is known in the art, there are many different types of advertising channels and devices that are utilized by businesses to broadcast their message to potential customers. Electronic media such as radio, television and internet are frequently utilized by businesses. Physical media such as print ads, billboards and other types of signs are also frequently utilized by businesses. One popular type of physical media for advertising that is utilized is commonly referred to as a sandwich board. As is known in the art, a sandwich board is a small two portion device having two surfaces that display a message thereon. Sandwich boards are often placed on a sidewalk or in front of a business where there is a pedestrian traffic.

While sandwich boards have been utilized for decades, there are limitations and deficiencies to the existing technology. The conventional sandwich board has a surface on each portion where either an advertising message must be written or releasably secured thereto. In order to change the message, the user of the sandwich board must manually facilitate the changing thereof. Another drawback to the conventional sandwich board is the lack of any integrated visual attention focusing element. Many user of conventional sandwich boards will employ balloons or other similar elements in an effort to draw an individual's attention to the sandwich board.

Accordingly, there is a need for an advertising device that includes two portions hingedly coupled wherein each portion includes an upper display area and a lower display area wherein the upper display area provides a programmable visual alert signal to individuals proximate thereto.

### SUMMARY OF THE INVENTION

It is the object of the present invention to provide an advertising device that is configured to be superposed a suitable horizontal support surface wherein the present invention includes a first portion and a second portion that are rectangular in shape and hingedly coupled.

Another object of the present invention is to provide a sandwich board advertising device that is configured to display a first message and a second message wherein the first portion and the second portion have a lower display area and an upper display area.

A further object of the present invention is to provide an advertising device that is configured to be superposed a suitable horizontal support surface wherein the lower display area is configured to have replaceable written indicia or a message placard releasably secured thereto.

Yet a further object of the present invention is to provide a sandwich board advertising device that is configured to display a first message and a second message wherein the upper display area has a frame member secured thereto.

Still another object of the present invention is to provide an advertising device that is configured to be superposed a suitable horizontal support surface wherein the upper display area wherein the frame member has a LED display unit disposed therein.

An additional object of the present invention is to provide a sandwich board advertising device that is configured to display a first message and a second message wherein the display unit is programmable via a remote interface such as but not limited to a software application.

Yet a further object of the present invention is to provide an advertising device that is configured to be superposed a suitable horizontal support surface wherein the present invention further includes a securing member operably coupled to the first portion and second portion proximate the bottom thereof and is operable to maintain an angle therebetween ensuing placement of the advertising device.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a front perspective view of the present invention; and

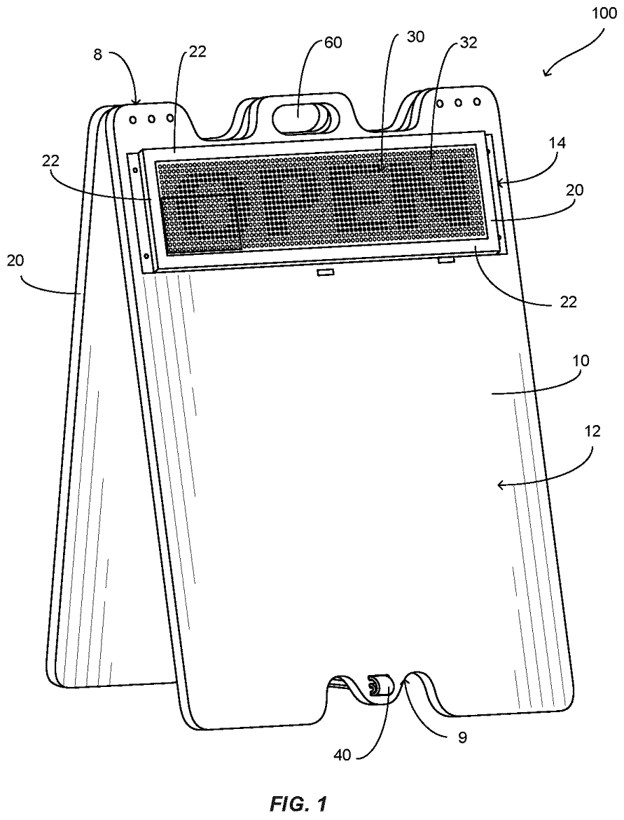

FIG. 2 is a front view of the present invention; and

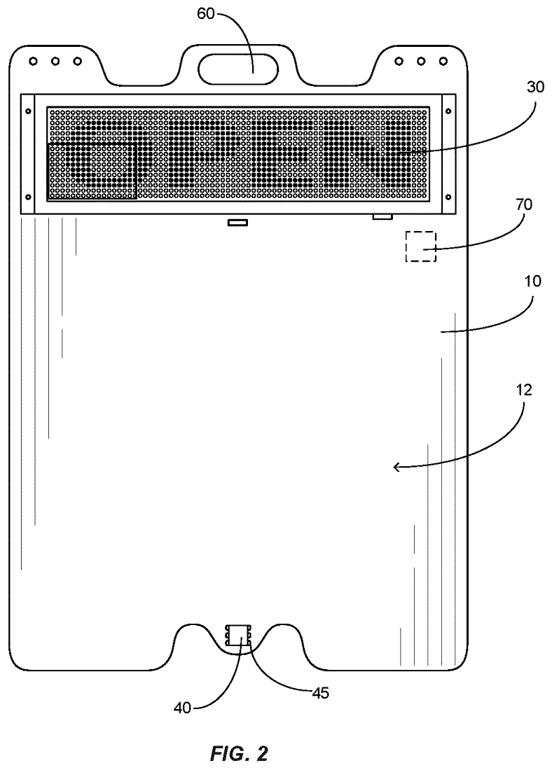

FIG. 3 is a detailed view of the securing member and slots of the present invention.

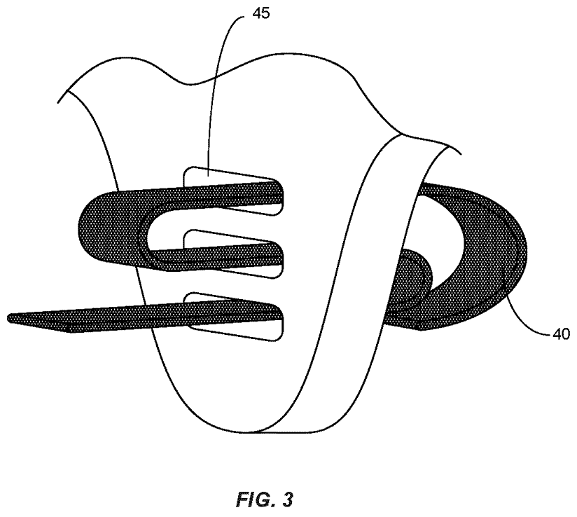

### DETAILED DESCRIPTION

Referring now to the drawings submitted herewith, wherein various elements depicted therein are not necessarily drawn to scale and wherein through the views and figures like elements are referenced with identical reference numerals, there is illustrated an advertising device 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the advertising device 100 is configured to be superposed a suitable horizontal support surface and display at least one message to individuals proximate thereto. It should be understood within the scope of the present invention that the advertising device 100 is manufactured from a rigid lightweight material such as but not limited to aluminum panel. Those skilled in the art will recognize that utilization of a rigid warp resistant material is desirable for the application of the present invention. It should be further understood within the scope of the present invention that the advertising device 100 could be manufactured in alternate sizes and shapes.

The advertising device 100 includes a first portion 10 and a second portion 20 that are hingedly coupled along an upper perimeter edge 8. The first portion 10 and second portion 20 are identically constructed and as such all forgoing discussions in relation to the first portion 10 should be understood to apply to the second portion 20. Alternative embodiments thereof are additionally discussed herein. The first portion 10 is generally rectangular in shape and manufactured from a lightweight rigid material. The first portion 10 includes a lower display area 12 and an upper display area 30. The lower display area 12 is configured to be utilized in a first mode or a second mode. In the first mode of the lower display area 12 is manufactured from a material that facilitates an ability for a user to write indicia thereon wherein the indicia is removable. By way of example but not limitation that first mode can be facilitated through utilization of chalkboard or dry erase material. In the second mode of the lower display area 12, the lower display area 12 has an additional placard or similar element releasably secured thereto. It should be understood that the second mode could employ the same material as the first mode wherein a user of the advertising device 100 would utilize a placard having a releasable chemical adhesive thereon so as to secure the placard to the lower display area 12. It should be further understood within the scope of the present invention that the lower display area 12 could be utilized in the first mode and second mode simultaneously.

The upper display area 30 includes a graphical display unit 32. The graphical display unit 32 is a LED display or similar electronic device that is configured to provide an electronic visual message. The graphical display unit 32 is controlled utilizing controller 70. Controller 70 is integrally mounted to the advertising device 100 and has the necessary electronics to receive, store, manipulate and transmit data. In a preferred embodiment of the present invention the controller 70 can be interfaced with utilizing a software application in order to facilitate changing of the message displayed on the graphical display unit 32.

The upper display area 30 includes a frame member 20 circumferentially disposed thereto. The frame member 20 includes wall members 22 that are integrally formed utilizing suitable techniques. The frame member 20 is superposed the first portion 10 utilizing suitable techniques such as but not limited to mechanical fasteners. The frame member 20 extends outward from the first portion 10 and is perpendicular thereto. The frame member 20 is manufactured from a material such as but not limited to aluminum and is operable to provide protection for the graphical display unit 32. While the upper display area 30 is illustrated herein as being rectangular in shape in the Figures submitted herewith, it is contemplated within the scope of the present invention that the upper display area 30 could be provided in alternate shapes and sizes. It is further contemplated within the scope of the present invention that the upper display area 30 as described herein could be present on both the first portion 10 and second portion 20 or on only one thereof.

The first portion 10 further includes slots 45 and a securing member 40 operably coupled thereto. The slots 45 are formed in the first portion 10 proximate the lower perimeter edge 9. Slots 45 are generally elongated in shape being horizontally oriented on the first portion 10. While three slots 45 are illustrated herein, it is contemplated within the scope of the present invention that the alternate quantities of slots 45 could be formed in the first portion 10. The slots 45 are operably coupled with the securing member 40. Securing member 40 is a nylon strap or similar material and is configured to be operably coupled between the first portion 10 and second portion 20 of the advertising device 100. The securing member 40 is set to a length so as to maintain a desired angle between the first portion 10 and second portion 20 ensuing placement of the advertising device 100. It is contemplated within the scope of the present invention that the advertising device 100 could employ alternate elements in place of and/or in conjunction with the securing member 40 in order to maintain a desired angle between the first portion 10 and second portion 20.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An advertising device that is operable to be placed on a horizontal support surface wherein the advertising device comprises:
a first portion and a second portion, said first portion and said second portion being of a same size and shape, said first portion and said second portion being hingedly coupled at an upper perimeter edge of said first portion and an upper perimeter edge of said second portion, said first portion having a lower display area and an upper display area, said second portion having a lower display area and an upper display area, said lower display area of said first portion having a first mode and a second mode, said lower display area of said second portion having a first mode and a second mode, said upper display area of said first portion having a graphical display unit;
a controller, said controller being mounted within the advertising device, said controller being operably coupled to said graphical display unit present on said upper display area, said controller having necessary electronics to receive, store, transmit and manipulate data.

2. The advertising device operable to be placed on a horizontal support surface as recited in claim 1, and further including a frame member, said frame member being circumferentially disposed around said upper display area having the graphical display unit therein, said frame member being comprised of a plurality of wall members, said plurality of wall members being secured to said first portion, said plurality of wall members being perpendicular with said first portion and extending outward therefrom.

3. The advertising device operable to be placed on a horizontal support surface as recited in claim 2, wherein said upper display area of said second portion includes a graphical display unit.

4. The advertising device operable to be placed on a horizontal support surface as recited in claim 3, wherein said graphical display unit present in said upper display area of said second portion has a frame member circumferentially disposed thereto.

5. The advertising device operable to be placed on a horizontal support surface as recited in claim 4, wherein in said first mode said lower display area of said first portion is configured to receive indicia thereon.

6. The advertising device operable to be placed on a horizontal support surface as recited in claim 5, wherein in said second mode said lower display area of said first portion is configured to have a placard releasably secured thereto.

7. The advertising device operable to be placed on a horizontal support surface as recited in claim 4, and further including a plurality of slots, said plurality of slots being horizontal in orientation, said plurality of slots being formed in said first portion and said second portion proximate a lower perimeter edge thereof.

8. The advertising device operable to be placed on a horizontal support surface as recited in claim 7, and further including a strap member, said strap member being operably coupled with said plurality of slots formed in said first portion and said second portion, said strap member configured to control an angle between said first portion and said second portion ensuing placement of the advertising device.

9. The advertising device operable to be placed on a horizontal support surface as recited in claim 8, wherein said first portion and said second portion are planar in manner and rectangular in shape.

10. The advertising device operable to be placed on a horizontal support surface as recited in claim 9, wherein in said first mode said lower display area of said second portion is configured to receive indicia thereon.

11. The advertising device operable to be placed on a horizontal support surface as recited in claim 10, wherein in said second mode said lower display area of said second portion is configured to have a placard releasably secured thereto.
